(19) United States
(12) Patent Application Publication
(10) Pub. No.: US 2007/0072985 A1
(43) Pub. Date: Mar. 29, 2007

(54) METHOD OF MAKING A FLUOROPOLYMER

(75) Inventors: KLAUS HINTZER, Kasti (DE); Michael Jurgens, Neuoetting (DE); Haraid Kaspar, Burgkichen (DE); Herbert Koenigsmann, Burgkichen (DE); Kai Helmut Lochhaas, Neuoetting (DE); Andreas R. Maurer, Langenneufnach (DE); Timan Zipplies, Burghausen (DE)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/535,249

(22) Filed: Sep. 26, 2006

(30) Foreign Application Priority Data
Sep. 27, 2005 (GB) GB0519613.4

(51) Int. Cl. C08L 27/12

(52) U.S. Cl. 524/544; 526/242

(57) ABSTRACT

The present invention provides a method of making a fluoropolymer comprising: (i) providing an aqueous dispersion of fluoropolymer particles by polymerizing one or more fluorinated olefins and optionally one or more fluorinated or non-fluorinated comonomers in an aqueous emulsion polymerization whereby the polymerization is initiated in the absence of a fluorinated surfactant and whereby no fluorinated surfactant is added during polymerization; (ii) recovering the fluoropolymer from the aqueous dispersion thereby obtaining said fluoropolymer and waste water; and (iii) contacting said waste water with an anion exchange resin; or alternatively to steps (ii) and (iii), contacting said aqueous dispersion with an anion exchange resin and subsequently separating said anion exchange resin from said aqueous dispersion.

### CROSS REFERENCE TO RELATED APPLICATIONS

This application claims priority to Great Britain Application No. GB0519613.4, filed on Sep. 27, 2005, herein incorporated by reference in its entirety.

The present invention relates to the aqueous emulsion polymerization of fluorinated olefins to produce fluoropolymers.

Fluoropolymers, i.e. polymers having a fluorinated backbone, have been long known and have been used in a variety of applications because of several desirable properties such as heat resistance, chemical resistance, weatherability, UV-stability etc. The various fluoropolymers are for example described in “Modern Fluoropolymers”, edited by John Scheirs, Wiley Science 1997. Commonly known or commercially employed fluoropolymers include polytetrafluoroethylene (PTFE), copolymers of tetrafluoroethylene (TFE) and hexafluoropropylene (HFP) (FEP polymers), perfluoroalkoxy copolymers (PFA), ethylenetetrafluoroethylene (ETFE) copolymers, terpolymers of tetrafluoroethylene, hexafluoropropylene and vinylidene fluoride (THV) and polyvinylidene fluoride polymers (PVDF). Commercially employed fluoropolymers also include fluoroelastomers and thermoplastic fluoropolymers.

Several methods are known to produce fluoropolymers. Such methods include suspension polymerization as disclosed in e.g. U.S. Pat. No. 3,855,191, U.S. Pat. No. 4, 439,385 and EP 649863; aqueous: emulsion polymerization as disclosed in e. g. U.S. Pat. No. 3,635,926 and U.S. Pat. No. 4,262,101; solution polymerization as disclosed in U.S. Pat. Nos. 3,642,742, 4,588,796 and 5,663,255; polymerization using supercritical CO₂ as disclosed in JP 46011031 and EP 964009 and polymerization in the gas phase as disclosed in U.S. Pat. No. 4,861,845.

Currently, the most commonly employed polymerization methods include suspension polymerization and especially aqueous emulsion polymerization. The aqueous emulsion polymerization normally involves the polymerization in the presence of a fluorinated surfactant, which is generally used for the stabilization of the polymer particles formed. The suspension polymerization generally does not involve the use of surfactant but results in substantially larger polymer particles than in case of the aqueous emulsion polymerization. Thus, the polymer particles in case of suspension polymerization will quickly settle out whereas in case of dispersions obtained in emulsion polymerization generally good stability over a long period of time is obtained.

The aqueous emulsion polymerization process in the presence of fluorinated surfactants is a desirable process to produce fluoropolymers because it can yield stable fluoropolymer particle dispersions in high yield and in a more environmental friendly way than for example polymerizations conducted in an organic solvent. Frequently, the emulsion polymerization process is carried out using a perfluoroalkanoic acid or salt thereof as a surfactant. These surfactants are typically used as they provide a wide variety of desirable properties such as high speed of polymerization, good copolymerization properties of fluorinated olefins with comonomers, small particle sizes of the resulting dispersion can be achieved, good polymerization yields i.e. a high amount of solids can be produced, good dispersion stability, etc. However, environmental concerns have been raised against these surfactants and moreover these surfactants are generally expensive. Accordingly, attempts have been made in the art to conduct the emulsion polymerization process without the use of a fluorinated surfactant.

An aqueous emulsion polymerization wherein no surfactant is used has been described in U.S. Pat. No. 5,453,477, WO 96/24622 and WO 97/17381 to generally produce homo- and copolymers of chlorotrifluoroethylene (CTFE). For example, WO 97/17381 discloses an aqueous emulsion polymerization in the absence of a surfactant wherein a radical initiator system of a reducing agent and oxidizing agent is used to initiate the polymerization and whereby the initiator system is added in one or more further charges during the polymerization. So-called emulsifier free polymerization has further been disclosed in WO 02/88206 and WO 02/88203. In the latter PCT application, the use of dimethyl ether or methyl tertiary butyl ether is taught to minimize formation of low molecular weight fractions that may be extractable from the fluoropolymer. WO 02/88207 teaches an emulsifier free polymerization using certain chain transfer agents to minimize formation of water soluble fluorinated compounds. An emulsifier free polymerization is further disclosed in RU 2158274 for making an elastomeric copolymer of hexafluoropropylene and vinylidene fluoride.

While the emulsifier free polymerizations disclosed in the art may solve the environmental problems associated with the use of perfluoroalkanoic acids and salts thereof as surfactants, it has been found that fluoropolymer dispersions resulting from an emulsifier free polymerization still contain a substantial amount of low molecular weight fluorinated compounds, which is still an environmental disadvantage. Moreover, the presence of such low molecular weight compounds may not be desirable in certain applications in which the fluoropolymer is being used.

Because of the desirable properties of fluoropolymer dispersions produced in the presence of a fluorinated surfactant and in particular in the presence of perfluoroalkanoic acids and salts thereof as surfactants it has been taught to recover the fluorinated surfactant from waste water streams and to remove them from the resulting dispersion after polymerization as disclosed in WO 99/62830, WO 99/62858 and WO 00/35971. The so recovered fluorinated surfactant can then be re-used in a subsequent polymerization. The recovery thus addresses the cost of the fluorinated surfactant and to some extent the environmental concern. A disadvantage of the recovery method is that it requires the addition of non-ionic surfactants to avoid blocking of the anion exchange resin. The use of these non-ionic surfactants increases costs in the recovery process. Further, in some applications the presence of non-ionic surfactants is undesired or not acceptable.

It would now be desirable to find an alternative way of producing fluoropolymers without the need to add a fluorinated surfactant and in particular a perfluoroalkanoic acid or salt thereof as surfactant. It would furthermore be desirable to find a method that leads to more environmentally friendly products. Still further, it would be desirable to find a method that is easy, convenient and cost effective. Preferably, the fluoropolymers resulting from such method have equal or improved properties in their typical applications.

In accordance with the present invention there is provided a method of making a fluoropolymer comprising:
(i) providing an aqueous dispersion of fluoropolymer particles by polymerizing one or more fluorinated olefins and optionally one or more fluorinated or non-fluorinated comonomers in an aqueous emulsion polymerization whereby the polymerization is initiated in the absence of a fluorinated surfactant and whereby no fluorinated surfactant is added during polymerization;
(ii) recovering the fluoropolymer from the aqueous dispersion thereby obtaining said fluoropolymer and waste water;
(iii) and contacting said waste water with an anion exchange resin; or
   alternatively to steps (ii) and (iii), contacting said aqueous dispersion with an anion exchange resin and subsequently separating said anion exchange resin from said aqueous dispersion.

It has been found that fluoropolymer dispersions that are being produced without the addition of a fluorinated surfactant can be subjected to an anion exchange resin without the prior addition of a non-ionic surfactant. Accordingly, even if no non-ionic surfactant is present, blocking of the anion exchange resin does not occur. Likewise, waste water resulting from coagulating the fluoropolymer from the dispersion, which waste water may still contain small amounts of fluoropolymer particles, can also be subjected to an anion exchange resin without the addition of a non-ionic surfactant. Moreover, it has been found that the anion exchange resin is highly effective in removing low molecular weight fluorinated compounds that have one or more ionic end groups. As a result, fluoropolymers can be obtained that are more environmentally friendly and that may provide improved properties. For example, when the amount of ionic groups in the fluoropolymer product per unit mass is large, the processing of the fluoropolymer may be negatively influenced and/or the fluoropolymer may not have the desired degree of purity for particular applications. This may be particularly so if the fluoropolymer is used to make fluoroelastomers which are being used in semi-conductor applications or in fuel management systems.

Aqueous Emulsion Polymerization

Except for the absence of fluorinated surfactant, the aqueous emulsion polymerization process is generally conducted in the commonly known manner. The reactor kettle is typically a pressurizable kettle capable of withstanding the internal pressures during the polymerization reaction. Typically, the reactor will include a mechanical agitator, which will produce thorough mixing of the reactor contents and heat exchange system.

Any quantity of the fluoromonomer(s) may be charged to the reactor vessel. The monomers may be charged batchwise or in a continuous or semi continuous manner. By semi-continuous is meant that a plurality of batches of the monomer are charged to the vessel during the course of the polymerization. The independent rate at which the monomers are added to the vessel will depend on; the consumption rate of the particular monomer with time. Preferably, the rate of addition of monomer will equal the rate of consumption of monomer, i.e. conversion of monomer into polymer.

The reaction kettle is charged with water, the amounts of which are not critical. Generally a chain transfer agent is used although not required. When used, the chain transfer agent is typically charged to the reaction vessel prior to the initiation of the polymerization. Further additions of chain transfer agent in a continuous or semi-continuous way during the polymerization may also be carried out. For example, a fluoropolymer having a bimodal molecular weight distribution is conveniently prepared by first polymerizing monomers in the presence of an initial amount of chain transfer agent and then adding at a later point in the polymerization further chain transfer agent together with additional monomer.

Chain transfer agents that may be used in accordance with the present invention include ethers such as dimethyl ether and methyl tertiary butyl ether, alkanes such as methane, ethane, propane, butane and pentane, bromine or iodine containing chain transfer agents, esters such as diethyl malonate, dimethyl malonate and ethyl acetates, alcohols such as methanol and ethanol and ketones such as acetone and cyclic ethers such as tetrahydrofuran.

The polymerization is usually initiated after an initial charge of monomer by adding an initiator or initiator system to the aqueous phase. For example peroxides can be used as free radical initiators. Specific examples of peroxide initiators include, hydrogen peroxide, sodium or barium peroxide and diglutaric acid peroxide, and further water soluble per-acids and water soluble salts thereof such as e.g. ammonium, sodium or potassium salts. Examples of per-acids include peracetic acid. Esters of the peracid can be used as well and examples thereof include tert.-butylperoxyacetate and tert.-butylperoxypivalate. A further class of initiators that can be used are water soluble azo-compounds. Suitable redox systems for use as initiators include for example a combination of peroxodisulphate and hydrogen sulphite or disulphite, a combination of thiosulphate and peroxodisulphate or a combination of peroxodisulphate and hydrazine. Further initiators that can be used are ammonium- alkali- or earth alkali salts of persulfates, permanganic or manganic acid or manganic acids. The amount of initiator employed is typically between 0.03 and 2% by weight, preferably between 0.05 and 1% by weight based on the total weight of the polymerization mixture. The full amount of initiator may be added at the start of the polymerization or the initiator can be added to the polymerization in a continuous way during the polymerization until a conversion of 70 to 80%. One can also add part of the initiator at the start and the remainder in one or separate additional portions during the polymerization. Accelerators such as for example water-soluble salts of iron, copper and silver may preferably also be added.

During the initiation of the polymerization reaction, the sealed reactor kettle and its contents are typically pre-heated to the reaction temperature. Preferred polymerization temperatures are from 30° C. to 80° C. and the pressure is typically between 4 and 30 bar, in particular 8 to 20 bar. The aqueous emulsion polymerization system may further comprise auxiliaries, such as buffers and complex-formers.

The amount of polymer solids that can be obtained at the end of the polymerization is typically between 10% and 45% by weight, preferably between 20% and 40% by weight and the average particle size (volume average diameter) of the resulting fluoropolymer is typically at least 200 nm, generally 300 nm or more with a typical range being between 300 and 700 nm.

According to the present invention, the aqueous emulsion polymerization is carried out without the addition of a fluorinated surfactant. That is, the polymerization is initiated or started without the presence of a fluorinated surfactant and fluorinated surfactant is not added during the polymerization. According to one embodiment, the aqueous emulsion polymerization is carried out as disclosed in U.S. Pat. No. 5,453,477 and WO 97/17381. According to the emulsifier free aqueous emulsion polymerization disclosed in WO 97/17381 a radical initiator system of a reducing agent and oxidizing agent is used to initiate the polymerization and the initiator system is added in one or more further charges during the polymerization. Suitable oxidizing agents that can be used include persulfates such as potassium sulfate and ammonium sulfate, peroxides such as hydrogen peroxide, potassium peroxide, ammonium peroxide, tertiary butyl hydroperoxide, cumene peroxide and t-amyl hydroperoxide, manganese triacetate, potassium permanganate, ascorbic acid and mixtures thereof Suitable reducing agents include sodium sulfites such as sodium bisulfite, sodium sulfite, sodium pyrosulfite, sodium-m-bitsulfite, ammonium sulfite monohydrate and sodium thiosulphate, hydroxylamine, hydrazine, ferrous iron, organic acids such as oxalic acid and citric acid and mixtures thereof.

The amount of oxidizing agent added in the initial charge is typically between 10 and 10000 ppm. The amount of reducing agent in the initial charge is typically also between 10 and 10000 ppm. At least one further charge of oxidizing agent and reducing agent is added to the polymerization system in the course of the polymerization. The further addition(s) may be done batchwise or the further addition may be continuous.

According to another embodiment, the emulsifier free aqueous polymerization involves an initial charge of an oxidizing agent and a reducing agent and one or more further charges of either the reducing agent or oxidizing agent, but not both, in the course of the polymerization. This embodiment of the invention may have the advantage that the aqueous polymerization process can be conducted in an easy and convenient way while still yielding stable polymer dispersions at a high rate and in good yield.

The aqueous emulsion polymerization process of the present invention comprises the polymerization of at least one fluorinated olefin. Examples of fluorinated olefins include tetrafluoroethylene, chlorotrifluoroethylene, hexafluoropropylene and vinylidene fluoride. According to a particular embodiment of the present invention, the aqueous emulsion polymerization involves a copolymerization of one or more fluorinated olefins with optionally one or more fluorinated or non-fluorinated comonomers. Examples of comonomers include perfluoroalkyl vinyl monomers, ethylene, propylene, fluorinated allyl ethers, in particular perfluorinated allyl ethers and fluorinated vinyl ethers, in particular perfluorovinyl ethers. Further fluorinated and non-fluorinated monomers can be included as well.

Examples of fluorinated comonomers that may be used in the aqueous emulsion polymerization according to the invention include those corresponding to the formula:
CF₂═CF—O—R_{f} (I)
wherein R_{f} represents a perfluorinated aliphatic group that may contain one or more oxygen atoms. Preferably, the perfluorovinyl ethers correspond to the general formula:
CF₂═CFO(R_{f}O)ₙ(R′_{f}O)ₘR″_{f} (II)
wherein R_{f} and R′_{f} are different linear or branched perfluoroalkylene groups of 2-6 carbon atoms, m and n are independently 0-10, and R″_{f} is a perfluoroalkyl group of 1-6 carbon atoms. Examples of perfluorovinyl ethers according to the above formulas include perfluoro-2-propoxypropylvinyl ether (PPVE-2), perfluoro-3-methoxy-n-propylvinyl ether, perfluoro-2-methoxy-ethylvinyl ether, perfluoromethylvinyl ether (PMVE), perfluoro-n-propylvinyl ether (PPVE-1) and
CF₃—(CF₂)₂—O—CF(CF₃)—CF₂—O—CF(CF₃)—CF₂—O—CF═CF₂.
Still further, the polymerization may involve comonomers that have a functional group such as for example a group capable of participating in a peroxide cure reaction. Such functional groups include halogens such as Br or I as well as nitrile groups. Specific examples of such comonomers that may be listed here include
(a) bromo- or iodo- (per)fluoroalkyl-(per)fluorovinylethers having the formula:
   Z-R_{f}—O—CX═CX₂
   wherein each X may be the same or different and represents H or F, Z is Br or I, R_{f} is a (per)fluoroalkylene C₁-C₁₂, optionally containing chlorine and/or ether oxygen atoms; for example: BrCF₂—O—CF═CF₂, BrCF₂CF₂—O—CF═CF₂, BrCF₂CF₂CF₂—O—CF═CF₂, CF₃CFBrCF₂—O—CF═CF₂, and the like; and
(b) bromo- or iodo containing fluoroolefins such as those having the formula:
   Z′-(R_{f}′)ᵣ—CX═CX₂,
   wherein each X independently represents H or F, Z′ is Br or I, R_{f}′ is a perfluoroalkylene C₁-C₁₂, optionally containing chlorine atoms and r is 0 or 1; for instance:

bromotrifluoroethylene, 4-bromo-perfluorobutene- 1, and the like; or bromofluoroolefins such as 1-bromo-2,2-difluoroethylene and 4-bromo-3,3,4,4-tetrafluorobutene-1.

Examples of nitrile containing monomers that may be used include those that correspond to one of the following formulas:
CF₂═CF—CF₂—O—R_{f}—CN
CF₂═CFO(CF₂)_{L}CN
CF₂═CFO[CF₂CF(CF₃)O]_{g}(CF₂)ᵥOCF(CF₃)CN
CF₂═CF[OCF₂CF(CF₃)]ₖO(CF₂)ᵤCN
wherein L represents an integer of 2 to 12; g represents an integer of 0 to 4; k represents 1 or 2; v represents an integer of 0 to 6; u represents an integer of 1 to 6, R_{f} is a perfluoroalkylene or a bivalent perfluoroether group. Specific examples of nitrile containing liquid fluorinated monomers include perfluoro(8-cyano-5-methyl-3,6-dioxa-1-octene), CF₂═CFO(CF₂)₅CN, and CF₂═CFO(CF₂)₃OCF(CF₃)CN.

In accordance with a particular embodiment, a fluorinated liquid may be added to the polymerization system. By the term ‘liquid’ is meant that the compound should be liquid at the conditions of temperature and pressure employed in the polymerization process. Typically the fluorinated liquid has a boiling point of at least 50° C., preferably at least 80° C. at atmospheric pressure. Fluorinated liquids include in particular highly fluorinated hydrocarbons as well as liquid fluorinated monomers. The term ‘highly fluorinated’ in connection with the present invention is used to indicate compounds in which most and preferably all hydrogen atoms have been replaced with fluorine atoms as well as compounds wherein the majority of hydrogen atoms have been replaced with fluorine atoms and where most or all of the remainder of the hydrogen atoms has been replaced with bromine, chlorine or iodine. Typically, a highly fluorinated compound in connection with this invention will have only few, e.g., 1 or 2 hydrogen atoms replaced by a halogen other than fluorine and/or have only one or two hydrogen atoms remaining. When not all hydrogen atoms are replaced by fluorine or another halogen, i.e., the compound is not perfluorinated, the hydrogen atoms should generally be in a position on the compound such that substantially no chain transfer thereto occurs, i.e., such that the compound acts as an inert in the polymerization, and the compound does not participate in the free radical polymerization. Compounds in which all hydrogens have been replaced by fluorine and/or other halogen atoms are herein referred to as ‘perfluorinated’.

Liquid and fluorinated hydrocarbon compounds that can be used as fluorinated liquid, typically comprise between 3 and 25 carbon atoms, preferably between 5 and 20 carbon atoms and may contain up to 2 heteroatoms selected from oxygen, sulfur or nitrogen. Preferably the highly fluorinated hydrocarbon compound is a perfluorinated hydrocarbon compound. Suitable perfluorinated hydrocarbons include perfluorinated saturated linear, branched and/or cyclic aliphatic compounds such as a perfluorinated linear, branched or cyclic alkane; a perfluorinated aromatic compound such as perfluorinated benzene, or perfluorinated tetradecahydro phenanthene. It can also be a perfluorinated alkyl amine such as a perfluorinated trialkyl amine. It can further be a perfluorinated cyclic aliphatic, such as decalin; and preferably a heterocyclic aliphatic compound containing oxygen or sulfur in the ring, such as perfluoro-2-butyl tetrahydrofuran.

Specific examples of perfluorinated hydrocarbons include perfluoro-2-butyltetrahydrofuran, perfluorodecalin, perfluoromethyldecalin, perfluoromethylcyclohexane, perfluoro(1,3-dimethylcyclohexane), perfluorodimethyldecahydronaphthalene, perfluorofluorene, perfluoro(tetradecahydrophenanthrene), perfluorotetracosane, perfluorokerosenes, octafluoronaphthalene, oligomers of poly(chlorotrifluoroethylene), perfluoro(trialkylamine) such as perfluoro(tripropylamine), perfluoro(tributylamine), or perfluoro(tripentylamine), and octafluorotoluene, hexafluorobenzene, and commercial fluorinated solvents, such as Fluorinert FC-75, FC-72, FC-84, FC-77, FC-40, FC-43, FC-70, FC 5312 or FZ 348 all produced by 3M Company. A suitable inert liquid and highly fluorinated hydrocarbon compound is
C₃F₇—O—CF(CF₃)—CF₂—O—CHF—CF₃.

The fluorinated liquid may also comprise liquid fluorinated monomer alone or in combination with above described liquid fluorinated compounds. Examples of liquid fluorinated monomers include monomers that are liquid under the polymerization conditions and that are selected from (per)fluorinated vinyl ethers, (per)fluorinated allyl ethers and (per)fluorinated alkyl vinyl monomers.

In one particular embodiment, the fluorinated liquid is introduced in its gaseous state in the polymerization kettle, i.e., as a so-called hot gas. Alternatively, the fluorinated liquid may be added into the polymerization kettle as an aerosol by feeding the fluorinated liquid through an appropriate nozzle forming the aerosol. In a particular embodiment, the nozzle may be steam heated. The fluorinated liquid is typically used in an amount of 0.001 to 3% by weight based on the weight of fluoropolymer to be produced, preferably 0.005 to 1.5% by weight.

In accordance with a particular embodiment, the fluoropolymer produced is an amorphous fluoropolymer. Such polymers upon curing result in fluoroelastomers, which may find application in semi-conductor industry or in fuel management systems where they may be used in gaskets, fuel hoses and fuel tanks for example.

The fluoropolymer, whether amorphous or semi-crystalline, may have a partially fluorinated or fully fluorinated backbone. When the fluoropolymer has a partially fluorinated backbone it will typically have an amount of fluorine in the backbone of at least 20% by weight, for example at least 30% by weight and typically at least 50% by weight.

Removal or Recovery of Low Molecular Weight Fluorinated Compounds

It has been found that the fluoropolymer dispersion produced as described above contains low molecular weight fluorinated compounds that have anionic end groups. Examples of such anionic end groups include carboxylic acids, sulphonic acids and sulfuric acids including salts of these acids. The molecular weight and amount of these low molecular weight fluorinated compounds will generally vary with the conditions of the polymerization. Of most concern from an environmental point of view are those compounds that are fluorinated, have one or more ionic groups and have a molecular weight of 1000 g/mol or less, in particular 900 g/mol or less. It has been found that low molecular weight fluorinated compounds having a molecular weight of up to about 1000 g/mol, for example up to about 900 or 800 g/mol can be effectively and easily recovered with an anion exchange resin.

It will be understood by one skilled in the art that the structure of the low molecular weight fluorinated compounds will depend on the monomers being polymerized, polymerization conditions as well as the particular initiator system and/or chain transfer agents being used. In general, under the above-mentioned conditions of polymerization, the low molecular weight fluorinated compounds that may form will be compounds that have one or two ionic groups. Typically such ionic groups include carboxylic acids, sulphonic acids, sulfuric acids as well as salts of such acids. The low molecular weight fluorinated compounds will generally further comprise units deriving from the monomers involved in the polymerization. A variety of combination of such units may be found in the low molecular weight fluorinated compounds. For example, for a copolymerization of TFE, HFP and VDF the mixture of low molecular weight fluorinated compounds may be represented by the following general formula:
G-(tfe)ₐ(hfP)_{b}(vdf)_{c}-Z
wherein G and Z represent the end groups which may comprise an ionic group as set forth above, tfe, hfp, vdf, represent units deriving from the monomers TFE, HFP and VDF respectively, a is 0 to 10, b is 0 to 8, c is 0 to 15, for example 0 to 12 and the sum of a+b+c is between 1 and 15, for example 1 to 12. In a particular embodiment, G and Z independently represent Y—(CX₂)ₙ— wherein Y represents a hydrogen atom, a carboxylic acid group, sulphonic acid group or sulfuric acid group or a salt of such acids, each X independently represents H, F or CF₃ and n is 0 or 1 with the proviso that at least one of G and Z represents a group in which Y is other than a hydrogen atom.

According to one embodiment to recover low molecular weight fluorinated compounds, the dispersion may be coagulated and the fluoropolymer may be separated therefrom. For example, the fluoropolymer may be coagulated from the dispersion by the addition of a salt such as magnesium chloride or aluminum chloride, by the addition of an acid such HCl or oxalic acid, by the addition of an organic solvent such as a C1-C4 alkanol such as methanol or a ketone as disclosed in EP 1395634, by freeze coagulation or by high shear coagulation as described in e.g. EP 1268573.

After the coagulation, the precipitated polymer may be separated by filtration. Typically the separated fluoropolymer will be repeatedly washed and rinsed with water and/or water/solvent mixtures to remove undesired materials from the polymer.

The waste water that remains after coagulation and optional washing of the fluoropolymer contains the low molecular weight fluorinated compounds as well as a minor or small amounts of fluoropolymer particles that remained after coagulation and separation of the fluoropolymer. It has now been found that unlike the teaching in the prior art, the waste water can be contacted with an anion exchange resin without the addition or presence of a non-ionic surfactant. Without intending to be bound by any theory, it is believed that the non-ionic surfactant is not needed because of the generally larger particle size resulting in an emulsifier free polymerization compared to one conducted in the presence of a fluorinated surfactant such as perfluoroalkanoic acids and their salts. Another factor contributing may be that the particles would typically have a relatively large amount of ionic groups on their surface that remain after ion exchange.

The anion exchange process is preferably carried out in slightly acid, neutral or basic conditions. The ion exchange resin may be in the OH— form although anions like fluoride, chloride or sulfate may be used as well. The specific basicity of the ion exchange resin is not very critical. Strongly basic resins are preferred because of their higher efficiency. The process may be carried out by feeding the waste water through a column that contains the ion exchange resin or alternatively, the waste water may be stirred with the ion exchange resin and the anion exchange resin may thereafter be isolated by filtration. The low molecular weight fluorinated compounds may subsequently be recovered from the anion exchange resin by eluting the loaded resin. A suitable mixture for eluting the anion exchange resin is a mixture of ammonium chloride, methanol and water. Alternatively the low molecular weight fluorinated compounds can also be recovered from the ion exchange resin using strong acids (e.g. H₂SO₄) in the presence of organic solvents (e.g. methanol); the benefit of this process is, that the resulting mixture can be used to convert e.g. COO— containing species into the corresponding ester, or the O—SO₃-species into the OH— containing derivatives. The so recovered fluorinated compounds may, generally after purification and optional derivatization, be used itself as an emulsifier composition in an aqueous emulsion polymerization of fluorinated monomers. Still further, the recovered fluorinated compounds may be useful as reactants in the synthesis of for example fluorinated monomers.

Because there is no need to add a non-ionic surfactant to the waste water prior to contact with an anion exchange resin, the present method offers the advantage that no further waste water treatments are necessary to remove the non-ionic surfactant there from. Hence the process is both economically and ecologically attractive.

In an alternative embodiment according the invention, the fluoropolymer dispersion is contacted with the anion exchange resin. The conditions for treating the fluoropolymer dispersion are essentially the same as those described above for treating waste water and similar anion exchange resins can be used. Similar as described above for the treatment of waste water, the dispersion may be treated by guiding the dispersion over a column holding the anion exchange resin or by stirring the anion exchange resin with the dispersion followed by a subsequent filtration step. Also, in the case of treating the dispersion with an anion exchange resin has it been found that the presence of a non-ionic surfactant is not necessary to avoid coagulation of the dispersion and blocking of the anion exchange resin.

Further, this embodiment offers the advantage that a dispersion is obtained that is substantially free of fluorinated compounds having a molecular weight of 1000 g/mol or less and having one or more ionic groups. By substantially free is meant that the total amount of these fluorinated compounds with the said molecular weight are absent or present in an amount of not more than 500 ppm based on the amount of solids, generally in an amount of less than 100 ppm. The thus obtained dispersion can be readily used in coating of substrates such as fabrics, metal surfaces, glass and plastic surfaces.

In a further embodiment, the obtained dispersion from which fluorinated compounds having ionic groups and having a molecular weight of 1000 g/mol have been removed or in which their amount has been substantially removed, can be coagulated and the fluoropolymer may thereby be recovered from the dispersion. Compared to the embodiment wherein the coagulation of the dispersion is carried without prior removal of the fluorinated compounds, this embodiment offers the advantage that less contaminated waste water may be produced. In particular, the waste water resulting after coagulation of a dispersion, which is substantially free of low molecular weight fluorinated compounds, may not need further treatment to remove low molecular weight fluorinated compounds and/or any non-ionic surfactant.

The following examples illustrate the invention further without the intention to limit the invention thereto.

### EXAMPLES

Test Methods:

The latex particle size determination was conducted by means of dynamic light scattering with a Malvern Zetazizer 1000 HSA in accordance to ISO/DIS 13321. Prior to the measurements, the polymer latexes as yielded from the polymerisations were diluted with 0.001 mol/L KCl-solution, the measurement temperature was 20° C. in all cases.

The conductivity of water phases were recorded at room temperature (23° C.) using a Metrohm 712 Conductometer.

Molecular weight characterization of the water soluble low molecular weight fluorinated compounds was conducted by means of electro spray ionization mass spectrometry (ESI-MS). 40 mL-samples of polymer dispersion was centrifuged for 1 h at 5000 rpm. The transparent water phases were decanted and analyzed without any further workup. The various fluorinated compounds were separated by their molecular weight. The sample injection was accomplished using a Harvard Apparatus 11 Plus pump equipped with a Hamilton Gastight #101 syringe (1000 μl). A flow rate of 20 μl/min at 30° C. and a run time of 10 min after injection have been applied. Mass detection of the low molecular weight fluorinated compounds was accomplished by a Micromass Quattro 2 equipped with a ESI-MS interface (operating in negative ion mode). The raw data collection and analysis was conducted using the MassLynx Ver. 3.4 software.

Prior to measurement of the ion exchanged and non exchanged sample, the samples were spiked with C₈F₁₇SO₃⁻Li⁺ as an internal standard to a concentration of 0.99 μg/mL. The corresponding spectra were normalized to the intensity of internal standard in the non exchanged sample (5.12E+5 TIC) to compensate sensitivity fluctuations between the two runs. The peaks with intensities above 2% of internal standard (concentration >20 ng/mL) were evaluated with the assumption of a linear MS response in a mass range up to 600 m/z. A particular fluorinated low molecular weight compound was considered identified when the maximum deviation of the experimental value to the calculated one was below +/−0.2 m/z.

### Example 1

A polymerisation kettle with a total volume of 49 l equipped with an impeller agitator was charged with 29 l deionised water. The oxygen free kettle was heated up to 70° C. and the agitation system was set to 240 rpm. The kettle was charged with 6 g dimethylether to a pressure of 0.5 bar absolute, with 1040 g hexafluoropropylene (HFP) to 8.0 bar absolute and with 450 g vinylidenedifluoride (VDF) to 15.5 bar absolute reaction pressure. The polymerisation was initiated by 160 g 25% aqueous APS solution (ammonium peroxodisulfate). As the reaction started, the reaction pressure of 15.5 bar absolute was maintained by the feeding HFP and VDF into the gas phase with a feeding ratio HFP (kg)/VDF (kg) of 0.653. The reaction temperature of 70° C. was also maintained. After 5 h the feeding of 8.17 kg TFE was completed and the monomer valves were closed and the monomers were reacted down to 10.6 bar absolute within 10 min. The reactor was vented and flushed with N₂ in three cycles.

The so obtained 42.6 kg polymer dispersion had a solid content of 33.0%. The latex particle diameter was 460 nm according to dynamic light scattering. For the removal of ionic low molecular weight fluorinated compounds, the dispersion was set to pH=7 using sodium hydroxide and diluted with deionized water to a solid content of 20%. The conductivity was 1400 μS/cm.

A commercially available strong basic ion exchange resin Amberlite IRA402 Cl (capacity 1.3 mol/l) was used to remove the low molecular weight fluorinated compounds. A glass-column was filled with 350 mL anion exchange resin and rinsed with 10 bed volumes (BV) deionized water (1BV is equal to 350 mL). The dispersion from Example 1 was then passed through the ion exchange column from bottom to top. Flow rate was 0.5 to 1 BV/h. When 10 BV of dispersion had passed through the ion exchange column, a sample was taken and the residual low molecular weight fluorinated compound content was measured using ESI-MS. No clogging of the column was observed and the solid content of the dispersion and the average particle size of the latex after removal of the low molecular weight fluorinated compounds was unchanged. The pH of the dispersion after ion exchange was pH=3. The conductivity was 1920 μS/cm.

Based on the internal standard, a total amount of low molecular weight fluorinated compounds of about 600 μg/mL before ion exchange was calculated and less than 60 μg/mL after ion-exchange. Thus removal rate of the identified fluorinated low molecular weight compounds is about 90%.

The following low molecular weight fluorinated compounds were identified in the water phase before/after ion exchange treatment:

| | signal intensity | signal intensity | |
|---|---|---|---|
| Structural assignment | before ion exchange | after ion exchange | intensity decrease |
| (m/z exp./calc.) | [TIC] | [TIC] | [%] |
| [H-(VDF)₂-SO₄]⁻ | 1.7 · 10⁶ | 2.5 · 10⁴ | 98.5 |
| (224.86/224.98) | | | |
| [H-(VDF)₃-SO₄]⁻ | 2.2 · 10⁶ | 3.5 · 10⁴ | 98.4 |
| (288.92/288.99) | | | |
| [H-(VDF)₄-SO₄]⁻ | 3.0 · 10⁶ | 1.3 · 10⁴ | 99.6 |
| (352.92/353.00) | | | |
| [H-(VDF)₅-SO₄]⁻ | 1.5 · 10⁶ | 4.4 · 10³ | 99.7 |
| (417.04/417.01) | | | |
| [H-(VDF)₆-SO₄]⁻ | 6.2 · 10⁵ | 4.9 · 10³ | 99.2 |
| (481.04/481.02) | | | |
| [H-(VDF)₇-SO₄]⁻ | 1.2 · 10⁵ | 1.6 · 10³ | 98.7 |
| (544.92/545.03) | | | |
| [H-(VDF)₈-SO₄]⁻ | 3.0 · 10⁴ | 1.4 · 10³ | 95.3 |
| (608.93/609.04) | | | |
| [H-(VDF)₁-CH₂COO]⁻ | 5.1 · 10⁶ | 1.8 · 10⁴ | 99.6 |
| (122.96/123.03) | | | |
| [H-C(CF₃)F-COO]⁻ | 7.2 · 10⁶ | 3.3 · 10⁵ | 95.4 |
| (144.95/144.99) | | | |
| [H-(HFP)₁-C(CF₃)F-COO]⁻ | 3.3 · 10⁵ | 6.1 · 10³ | 98.2 |
| (295.03/294.98) | | | |
| [H-(VDF)₂-(HFP)₁-SO₄]⁻ | 2.9 · 10⁵ | 6.8 · 10³ | 97.6 |
| (374.95/374.97) | | | |
| [H-(VDF)₃-(HFP)₁-SO₄]⁻ | 1.7 · 10⁵ | 1.1 · 10⁴ | 93.5 |
| (439.00/438.99) | | | |
| [H-(VDF)₄-(HFP)₁-SO₄]⁻ | 6.4 · 10⁴ | 2.7 · 10³ | 95.8 |
| (502.93/503.00) | | | |
| [H-(VDF)₁-(HFP)₂-SO₄]⁻ | 5.0 · 10⁵ | 1.3 · 10⁴ | 97.4 |
| (460.93/460.95) | | | |
| H-(VDF)₁-C(CF₃)F-COO]- | 7.2 · 10⁵ | 6.4 · 10⁴ | 91.1 |
| (208.93/209.00) | | | |
| H-(VDF)₂-C(CF₃)F-COO]- | 5,8 · 10⁵ | 3.9 · 10⁴ | 93.3 |
| (272.91/273.02) | | | |
| [SO₄-(VDF)₂-SO₄H]⁻ | 2.6 · 10⁵ | 1.8 · 10⁴ | 93.1 |
| (320.96/320.94) | | | |
| [SO₄-(VDF)₃-SO₄H]⁻ | 1.7 · 10⁵ | 2.1 · 10⁴ | 87.6 |
| (384.82/384.95) | | | |
| [SO₄-(VDF)₄-SO₄H]⁻ | 2.7 · 10⁵ | 5.3 · 10³ | 98.0 |
| (449.00/448.96) | | | |
| [SO₄-(VDF)₂-(HFP)₁- | 2.4 · 10⁵ | 4.5 · 10³ | 98.1 |
| SO₄H]- | | | |
| (421.06/420.93) | | | |
| [SO₄-(VDF)₃-(HFP)₁- | 3.0 · 10⁴ | 1.1 · 10³ | 96.3 |
| SO₄H]- | | | |
| (485.05/484.94) | | | |
| [SO₄-(VDF)₁-C(CF₃)F- | 6.9 · 10⁵ | 6.6 · 10⁴ | 90.4 |
| COOH]⁻ | | | |
| (305.02/304.96) | | | |
| [SO₄-(VDF)₂-C(CF₃)F- | 2.8 · 10⁵ | 1.3 · 10⁴ | 95.4 |
| COOH]⁻ | | | |
| (368.95/368.97) | | | |
| [SO₄-(VDF)₃-C(CF₃)F- | 3.6 · 10⁵ | 5.1 · 10³ | 98.6 |
| COOH]⁻ | | | |
| (432.94/432.98) | | | |
| [OOCCH₂-(VDF)₁-CH₂- | 1.9 · 10⁶ | 6.0 · 10⁴ | 96.8 |
| COOH]⁻ | | | |
| (180.94/181.03) | | | |
| [OOCCH₂-(VDF)₂-CH₂- | 9.8 · 10⁶ | 1.0 · 10⁵ | 99.0 |
| COOH]⁻ | | | |
| (244.98/245.04) | | | |

TIC = mass signal intensity (Total Ion Current)

### Example 2

A polymerization kettle with a total volume of 49 l equipped with an impeller agitator was charged with 29.0 l deionized water. The oxygen free kettle was then heated up to 70° C. and the agitation system was set to 240 rpm. The kettle was charged with 54 g 25% aqueous ammonia solution, 30 g PPVE-2, 1710 g HFP to a pressure of 12.1 bar absolute, with 200 g VDF to 15.0 bar, with 220 g TFE to 17.0 bar absolute reaction pressure. The polymerization was initiated by the addition of 40 g ammonium peroxodisulfate (APS) dissolved into 120 ml water. As the reaction starts, the reaction pressure of 17.0 bar absolute was maintained by the feeding TFE, VDF, HFP and PPVE-2 into the gas phase with a feeding ratio VDF (kg)/TFE (kg) of 1.318 and HFP (kg)/TFE (kg) of 1.135. The reaction temperature of 70° C. was also maintained. In a duration of 1.5 h, 25 g of PPVE-2 was further fed as hot spray aerosol. After feeding 1.8 kg TFE (corresponds to 50% monomer target feed after 62 min polymerization time), a portion of 75 g dimethylether chain transfer agent was added into the vessel which was resulting in a drastic declination of the monomer uptake. The monomer feed was maintained for another polymerization period of 285 min and an additional quantity of 25 g of PPVE-2 was fed as hot spray aerosol another quantity. After that period, a monomer feed 3.6 kg TFE was accomplished. The monomer feed was interrupted and the monomer valves were closed. Within 30 min, the monomer gas phase had reacted down to a vessel pressure of 12.2 bar; then the reactor was vented and flushed with N₂ in three cycles.

The so-obtained 43.3 kg polymer dispersion with a solid content of 33.4% was recovered at the bottom of the reactor and it consisted of latex particles having 540 nm in diameter according to dynamic light scattering. This dispersion was further analyzed by means of ESI-MS.

The low molecular weight compounds were removed and characterized as described in Example 1.

The total amount of fluorinated low molecular weight compounds in the water phase of the dispersion was calculated to be about 1700 μg/mL. After ion exchange, the amount thereof was reduced to 100 ppm.

The following low molecular weight fluorinated compounds could be characterized:

| | | | |
|---|---|---|---|
| | signal intensity | signal intensity | |
| Structural assignment | before ion exchange | after ion exchange | intensity decrease |
| (m/z exp./calc.) | [TIC] | [TIC] | [%] |

1)

| | | | |
|---|---|---|---|
| [H-(VDF)₁-SO₄]⁻ | 2 · 10⁶ | 9 · 10³ | 99 |
| (160.83/160.97) | | | |
| to | | | |
| [H-(VDF)₅-SO₄]⁻ | 6 · 10⁴ | 5 · 10³ | 93 |
| (417.00/417.01) | | | |
| 2) | | | |
| [H-(TFE)₁-CH₂-COO]⁻ | 3 · 10⁶ | 3 · 10⁴ | 99 |
| (158.89/159.01) | | | |
| to | | | |
| [H-(TFE)₃-CF₂-COO]⁻ | 1 · 10⁵ | 3 · 10³ | 98 |
| (394.94/394.98) | | | |
| 3) | | | |
| [H-(VDF)₁-(TFE)₁-CH₂-COO]⁻ | 2 · 10⁶ | 2 · 10⁴ | 99 |
| (222.87/223.02) | | | |
| [H-(TFE)₁-(VDF)₁-SO₄]⁻ | 2 · 10⁶ | 3 · 10⁵ | 99 |
| (260.85/260.97) | | | |
| [H-(VDF)₁-(TFE)₂-CH₂-COO]⁻ | 7 · 10⁵ | 1 · 10⁴ | 98 |
| (322.96/323.01) | | | |
| [H-(TFE)₁-(VDF)₂-SO₄]⁻ | 2 · 10⁶ | 2 · 10⁶ | 99 |
| (325.02/324.98) | | | |
| 4) | | | |
| [H-(HFP)₁-(VDF)₁-SO₄]⁻ | 1 · 10⁶ | 6 · 10⁶ | 95 |
| (310.96/310.96) | | | |
| [H-(HFP)₁-(VDF)₂-SO₄]⁻ | 7 · 10⁶ | 3 · 10⁶ | 99 |
| (374.95/374.97) | | | |
| 5) | | | |
| [H-(VDF)₁-(TFE)₁-(HFP)₁-CH₂- | 5 · 10⁵ | 7 · 10³ | 99 |
| COO]⁻ | | | |
| (372.95/373.01) | | | |
| [H-(VDF)₁-(TFE)₁-(HFP)₁-CF₂- | 3 · 10⁵ | 1 · 10⁴ | 96 |
| COO]⁻ | | | |
| (408.94/408.99) | | | |
| [H-(VDF)₁-(TFE)₁-(HFP)₁-SO₄]⁻ | 1 · 10⁵ | 1 · 10⁴ | 99 |
| (410.82/410.96) | | | |
| 6) | | | |
| [SO₄-(VDF)₁-C(CF₃)F-COOH]⁻ | 7 · 10⁵ | 7 · 10⁴ | 90 |
| (305.02/304.96) | | | |
| to | | | |
| [SO₄-(VDF)₃-C(CF₃)F-COOH]⁻ | 4 · 10⁵ | 5 · 10³ | 99 |
| (432.94/432.98) | | | |
| [OOCCH₂-(VDF)₁-CH₂-COOH]⁻ | 2 · 10⁶ | 6 · 10⁴ | 97 |
| (180.94/181.03) | | | |
| [OOCCH₂-(VDF)₂-CH₂-COOH]⁻ | 10 · 10⁶ | 1 · 10⁵ | 99 |
| (244.98/245.04) | | | |
| 7) | | | |
| ¹[H-C(CF₃)F-COO]⁻ | 2 · 10⁷ | 6 · 10⁴ | 99 |
| (144.89/144.99) | | | |

TIC = mass signal intensity (Total Ion Current)
¹ Other possible structure(S): HS₂O₅⁻ (calc. 144.93), [O-(VDF)₂-H]⁻ (calc. 145.03)
² Other possible structure(s): [H-(TFE)₂-CF₂-COO]⁻ (calc. 294.98)

What is claimed is:

1. Method of making a fluoropolymer comprising:
(i) providing an aqueous dispersion of fluoropolymer particles by polymerizing one or more fluorinated olefins and optionally one or more fluorinated or non-fluorinated comonomers in an aqueous emulsion polymerization whereby the polymerization is initiated in the absence of a fluorinated surfactant and whereby no fluorinated surfactant is added during polymerization;
(ii) recovering the fluoropolymer from the aqueous dispersion thereby obtaining said fluoropolymer and waste water;
(iii) and contacting said waste water with an anion exchange resin; or
(iv) alternatively to steps (ii) and (iii), contacting said aqueous dispersion with an anion exchange resin and subsequently separating said anion exchange resin from said aqueous dispersion.

2. Method according to claim 1 wherein said fluoropolymer is an amorphous fluoropolymer.

3. Method according to claim 1 wherein the fluoropolymer particles have a volume average diameter of 300 nm or more.

4. Method according to claim 1 wherein the fluoropolymer has a partially fluorinated backbone.

5. Method according to claim 1 wherein said aqueous dispersion and said waste water are substantially free of non-ionic surfactants.

6. Method according to claim 1 wherein the amount of solids in said aqueous dispersion is between 10 and 40% by weight.
